(19) United States
(12) Patent Application Publication
(10) Pub. No.: US 2009/0074018 A1
(43) Pub. Date: Mar. 19, 2009

(54) LASER DRIVING DEVICE

(76) Inventors: Hisashi Senga, Kadoma city (JP); Hiromichi Ishibashi, Ibaraki city (JP); Kenzo Ishibashi, Moriguchi city (JP); Haruhiko Mizuno, Takatsuki city (JP)

Correspondence Address: WENDEROTH, LIND & PONACK L.L.P., 2033 K. STREET, NW, SUITE 800, WASHINGTON, DC, 20006, US

(21) Appl. No.: 12/235,824

(22) Filed: Sep. 23, 2008

Related U.S. Application Data
(62) Division of application No. 10/938,536, filed on Sep. 13, 2004.

(30) Foreign Application Priority Data
Sep. 25, 2003 (JP) 2003-333220
Jul. 2, 2004 (JP) 2004-196211

(51) Int. Cl. H01S 3/10; H01S 3/00

(52) U.S. Cl. 372/25; 372/38.02

(57) ABSTRACT

A laser driving device is provided that can support a higher speed and drives a semiconductor laser (3) to emit light in a pulse-like manner in accordance with a digital signal. The laser driving device includes a temperature sensor (5), a recording pulse generator (1), an auxiliary pulse generator (4), and an adder (8). The temperature sensor (5) produces a measured temperature that changes in accordance with a temperature of the semiconductor laser. The recording pulse generator (1), the auxiliary pulse generator (4), and the adder (8) produce a pulse-like signal having a shape corresponding to the measured temperature.

### BACKGROUND OF THE INVENTION

1. Field of the Invention

The present invention relates to a laser driving device that is used for recording digital information onto a phase change recording type optical disk, such as a DVD, in an optical disk recorder or an optical disk drive for a personal computer.

2. Description of the Prior Art

Recently, rewritable optical disk drives have been in increasing demand for an auxiliary storage device of a computer, a consumer video recorder or the like. A semiconductor laser is typically used as a light source to record recording marks on an optical disk. In order to form suitable recording marks, it is necessary to drive the semiconductor laser to emit light pulses. The generation of the light pulses is realized conventionally by a laser driving device that adds pulses of current, which is supplied to the semiconductor laser.

In general, a laser driving device has a multi-pulse generation portion as a main portion as shown in FIG. 31. An input digital information signal (an NRZ signal) is converted into a write signal consisting of a plurality of pulses, which are supplied to the semiconductor laser via a current drive amplifier so that information is recorded or erased on the phase change recording type optical disk. A crystallized phase change type optical disk is irradiated by a laser beam from the semiconductor laser and is heated rapidly. Then, it is cooled rapidly, so that an amorphous mark is formed. Information “1” may be recorded sequentially depending on the contents of the digital information. In this situation, if a laser beam with constant power is used for irradiation, the middle portion of a mark may be heated excessively by accumulation of heat, which may cause a distortion of the mark formed. In order to avoid this phenomenon when recording continuous information, a so-called multi-pulse recording method is conventionally used, in which the semiconductor laser is driven to emit light intermittently.

However, requests for faster optical disk drives have been increasing year after year. If a clock rate of the recording pulse is increased so as to respond to the requests, each of the light pulses that constitute the multi-pulse light may not be emitted correctly. Namely, in the process for supplying current from the laser driving device to the semiconductor laser, the current may be affected more by a load such as a serial resistor, a capacitor, an inductor or wiring capacitance, which are incorporated in the semiconductor laser in an equivalent manner. As a result, the waveform of a pulse that should be originally rectangular may be distorted to a triangular shape, for example.

Therefore, conventionally, a type of waveform equalization is performed for each of the pulses (see Japanese unexamined patent publication No. 2002-298349, for example). Namely, current having a waveform such that a head portion of each pulse is larger than other portions is supplied to the semiconductor laser so as to compensate the waveform distortion due to the load.

However, it was found by the present inventors that excessive or insufficient compensation might happen in the conventional structure when trying to support a higher rate of speed (more than double speed).

In particular, a blue violet laser having oscillation wavelength of 400 nm has been commonly used as the semiconductor laser recently. For this, the data transfer rate in a normal speed recording is set to 36 Mbps. If the speed is further increased in the future, the rising period of the light pulse waveform is required to be 1.5 ns or less so that the light pulse waveform reaches a peak level in pulse modulation for the semiconductor laser.

However, due to its structure, a blue violet laser usually has a serial resistance three times or more than that of a red laser, which means that high speed modulation is more difficult because of the large influence of a low pass filter made up of the capacitance of the driving circuit and the serial resistance.

### SUMMARY OF THE INVENTION

An object of the present invention is to provide a laser driving device that can support higher speed.

It was found by the present inventors that the excessive or insufficient compensation is caused by a load variation which is due to a temperature variation, or in other words, this is one reason why a temperature margin of the system can not be enlarged.

Therefore, the present invention provides a laser driving device that can always perform an optimal pulse light emission by the following means, even if a load variation is generated due to a temperature variation.

According to a first aspect of the present invention, a laser driving device is provided for driving a semiconductor laser to emit light in a pulse-like manner in accordance with a digital signal. The laser driving device includes a measurement unit and a pulse generation unit. The measurement unit produces a measured value that changes in accordance with a temperature of the semiconductor laser. The pulse generation unit produces a pulse-like signal having a shape corresponding to the measured value.

Here, the digital signal means a recording signal or the like that is recorded onto an optical disk or the like by using the semiconductor laser, for example. In addition, the measured value that changes in accordance with a temperature of the semiconductor laser means a value that indicates the temperature of the semiconductor laser directly or indirectly, which includes a measured value of the temperature of the semiconductor laser and a measured value of a characteristic value of the semiconductor laser, more specifically, an electric characteristic value such as a voltage, a current value or a resistance. In addition, the pulse-like signal is delivered to the semiconductor laser as a pulse current, for example.

According to the laser driving device of the present invention, pulse light emission can be performed correctly, even if a load varies due to variation of temperature of the semiconductor laser.

According to the laser driving device of a second aspect of the present invention, the measurement unit is a device for measuring the temperature of the semiconductor laser.

According to the laser driving device of a third aspect of the present invention, the measurement unit is a device for measuring a voltage or a resistance of the semiconductor laser.

According to the laser driving device of a fourth aspect of the present invention, the pulse generation unit includes a first pulse generation portion, a second pulse generation portion and an adder. The first pulse generation portion generates a first pulse signal having a constant peak value. The second pulse generation portion generates a second pulse signal having a peak value that changes in accordance with the measured value. The adder adds the second pulse signal to the first pulse signal so as to produce the pulse-like signal.

According to the laser driving device of the present invention, it is possible to produce the pulse-like signal by compensating the first pulse signal corresponding to the digital signal by the second pulse signal corresponding to the measured value, for example.

According to the laser driving device of a fifth aspect of the present invention, the second pulse generation portion includes a third pulse generation portion and a fourth pulse generation portion. The third pulse generation portion generates a third pulse signal that is a forward direction signal with respect to the first pulse signal and has a peak value that changes in accordance with the measured value. The fourth pulse generation portion generates a fourth pulse signal that is a reverse direction signal with respect to the first pulse signal and has a peak value that changes in accordance with the measured value.

The third pulse signal and the fourth pulse signal are delivered as the second pulse signal to be added by the adder.

According to the laser driving device of the present invention, compensation of the first pulse signal can be performed not only in the forward direction but also in the reverse direction, for example. Therefore, it is possible to deliver a pulse-like signal having a more appropriate pulse shape.

According to the laser driving device of a sixth aspect of the present invention, the measurement unit is a device for measuring the temperature of the semiconductor laser. The second pulse generation portion further includes a corrected peak value decision unit for determining a peak value of the second pulse signal which has a steadily decreasing relationship in accordance with the measured value.

According to the laser driving device of the present invention, even if a load is changed due to temperature, the peak value of the second pulse signal can be changed uniquely corresponding to the temperature. In addition, the peak value can be controlled so that the peak value becomes higher as the temperature is lower. Therefore, even if a waveform distortion of the pulse signal becomes significant due to low temperature, the semiconductor laser can be supplied with a pulse-like signal having a waveform that can compensate for the distortion.

According to the laser driving device of a seventh aspect of the present invention, the measurement unit is a device for measuring a voltage or a resistance of the semiconductor laser. The second pulse generation portion further includes a corrected peak value decision unit for determining a peak value of the second pulse signal which has a steadily decreasing relationship in accordance with the measured value.

According to the laser driving device of the present invention, a voltage or a resistance of the semiconductor laser is measured so that variation of the load due to temperature can be measured. In addition, even if a waveform distortion of the pulse signal becomes significant due to a large load, the semiconductor laser can be supplied with a pulse-like signal having a waveform that can compensate for the distortion.

According to the laser driving device of a eighth aspect of the present invention, the digital signal is converted into a multi-pulse signal that includes at least a leading pulse signal and a trailing pulse signal corresponding to a succession number thereof. In addition, a signal width of the second pulse signal is smaller than a width of the leading pulse signal.

According to the laser driving device of the present invention, it is possible to more correctly compensate a waveform distortion of the leading pulse signal.

According to the laser driving device of a ninth aspect of the present invention, a signal width of the second pulse signal that is added to the trailing pulse signal is equal to a width of the trailing pulse signal.

According to the laser driving device of the present invention, it is possible to determine the signal width of the second pulse signal more easily. As a result, the laser driving device can be made more simply.

According to the laser driving device of a tenth aspect of the present invention, the digital signal is converted into a pulse signal having a width corresponding to a succession number. In addition, a signal width of the second pulse signal is smaller than a width of the pulse signal.

According to the laser driving device of the present invention, it is possible to more correctly compensate a waveform distortion of the leading pulse signal.

According to the laser driving device of an eleventh aspect of the present invention, a signal width of the second pulse signal is within the range of T/8-T/4 when T is a period of one channel clock.

According to the laser driving device of the present invention, it is possible to generate the second pulse signal having a signal width that is shorter than a signal width of a pulse signal corresponding to the digital signal. As a result, a waveform distortion of the pulse signal can be more correctly compensated.

According to the laser driving device of a twelfth aspect of the present invention, the third pulse signal is generated at a leading edge of the first pulse signal, and the fourth pulse signal is generated at a trailing edge of the first pulse signal.

According to the laser driving device of the present invention, it is possible to more correctly compensate waveform distortions at the leading edge and the trailing edge of the first pulse signal.

According to the laser driving device of a thirteenth aspect of the present invention, the pulse generation unit includes a pulse current source, a filter and a filter control portion. The pulse current source produces a pulse current in accordance with the digital signal. The filter is connected in parallel to the pulse current source and has a variable constant. The filter control portion controls the constant of the filter in accordance with the measured value.

According to the laser driving device of the present invention, it is possible to generate an appropriate light pulse waveform by using a filter that has a constant corresponding to variation of temperature, even if the load changes due to the variation of temperature of the semiconductor laser.

According to the laser driving device of a fourteenth aspect of the present invention, the filter control portion includes a unit for storing a constant of the filter to be controlled by the filter control portion in accordance with the measured value.

According to the laser driving device of the present invention, the filter control portion can obtain a filter constant corresponding to a measured value from the unit for storing a filter constant, and generates an appropriate light pulse waveform by using the filter of the obtained filter constant.

According to the laser driving device of a fifteenth aspect of the present invention, the filter includes a plurality of combinations, each of which comprises a capacitor and a switch connected in series.

According to the laser driving device of a sixteenth aspect of the present invention, the filter includes a plurality of combinations, each of which comprises a capacitor, a switch and a resistor connected in series.

According to the laser driving device of a seventeenth aspect of the present invention, the filter further includes a resistor connected between the ground and a node of the capacitor and the switch.

According to the laser driving device of an eighteenth aspect of the present invention, the filter further includes a resistor connected between the ground and one of the nodes of the capacitor, the switch and the resistor connected in series.

According to the laser driving device of a nineteenth aspect of the present invention, the filter can change the constant between a reproducing mode and a recording mode.

According to the laser driving device of a twentieth aspect of the present invention, at least one of a plurality of capacitors constituting the filter is connected to the outside of an integrated circuit.

According to the laser driving device of the present invention, the integrated circuit can be downsized.

According to the laser driving device of a twenty-first aspect of the present invention, the measurement unit is a device for measuring a voltage of the semiconductor laser. The filter control portion includes a resistance calculation unit and a control execution unit. The resistance calculation unit calculates a resistance of the semiconductor laser from an operating voltage of the semiconductor laser and an operation current of the semiconductor laser. The control execution unit controls the constant of the filter in accordance with the resistance.

According to the laser driving device of the present invention, an appropriate light pulse waveform can be generated by using a filter having a constant which corresponds to a temperature variation, even if resistance of the semiconductor laser is changed due to temperature variation.

According to the laser driving device of a twenty-second aspect of the present invention, the filter control portion includes a unit for storing a constant of the filter to be controlled by the control execution unit in accordance with the resistance.

According to the laser driving device of the present invention, the filter control portion can obtain a filter constant corresponding to the resistance from the unit for storing a filter constant, and can generate an appropriate light pulse waveform by using a filter of the obtained filter constant.

According to a twenty-third aspect of the present invention, an optical disk device is provided that includes an optical pickup and a disk driving device. The optical pickup includes a semiconductor laser for emitting a laser beam, the laser driving device of any of the first to twenty-second aspects and an optical component for leading the laser beam onto an optical disk. The disk driving device drives an optical disk.

The optical disk device according to the present invention has the laser driving device of any of the first to twenty-second aspects. Therefore, it can obtain the same effect as each laser driving device.

According to a twenty-fourth aspect of the present invention, a laser driving method for driving a semiconductor laser to emit pulse-like light in accordance with a digital signal is provided. The method includes a measuring step and a pulse generation step. The measuring step includes outputting a measured value that changes in accordance with a temperature of the semiconductor laser. The pulse generation step includes outputting a pulse-like signal having a shape corresponding to the measured value.

According to the laser driving method of the present invention, an appropriate pulse light emission can be performed, even if the load is changed due to temperature variation of the semiconductor laser.

According to a twenty-fifth aspect of the present invention, a laser driving integrated circuit for driving a semiconductor laser to emit pulse-like light in accordance with a digital signal is provided. The laser driving integrated circuit includes a first pulse generation portion, a second pulse generation portion and an adder. The first pulse generation portion generates a first pulse signal having a constant peak value. The second pulse generation portion generates a second pulse signal having a peak value that changes in accordance with a measured value, the measured value changing in accordance with the temperature of the semiconductor laser. The adder adds the second pulse signal to the first pulse signal so as to obtain a pulse-like signal to be delivered.

According to the laser driving integrated circuit of the present invention, it is possible to output the pulse-like signal by compensating the first pulse signal corresponding to the digital signal by the second pulse signal corresponding to the measured value, for example.

According to a twenty-sixth aspect of the present invention, a laser driving integrated circuit for driving a semiconductor laser to emit pulse-like light in accordance with a digital signal is provided. The laser driving integrated circuit includes a pulse current source, a filter and a filter control portion. The pulse current source produces a pulse current in accordance with the digital signal. The filter is connected to the pulse current source in parallel and has a variable constant. The filter control portion controls a constant of the filter in accordance with a measured value that changes in accordance with the temperature of the semiconductor laser.

According to the laser driving integrated circuit of the present invention, an appropriate light pulse waveform can be generated by using a filter having a constant corresponding to a temperature variation, even if the load changes due to temperature variation of the semiconductor laser.

According to the laser driving device of the present invention, it is possible to drive the semiconductor laser to emit light always with an optimal pulse waveform, regardless of temperature, so that the temperature margin can be enlarged for recording information on an optical disk.

### BRIEF DESCRIPTION OF THE DRAWINGS

FIG. 1 is a graph showing a relationship between equivalent serial resistance and temperature in a red laser.

FIG. 2 is a graph showing a relationship between equivalent serial resistance and temperature in a blue laser.

FIG. 3 shows the main structure of a laser driving device according to first and second embodiments of the present invention.

FIG. 4 is an operational sequence diagram of the laser driving device according to the first embodiment of the present invention.

FIG. 5 is a graph showing a relationship between a correction coefficient K and temperature.

FIG. 6 shows waveforms of a correction coefficient K, serial resistance Rs, laser drive current IL, and laser light emission at each temperature.

FIG. 7 is an operational sequence diagram of the laser driving device according to the second embodiment of the present invention.

FIG. 8 shows waveforms of a correction coefficient K, serial resistance Rs, laser drive current IL and laser light emission at each temperature.

FIG. 9 shows the main structure of a laser driving device according to a third embodiment of the present invention.

FIG. 10 is an operational sequence diagram of the laser driving device according to the third embodiment of the present invention.

FIG. 11 shows graphs of relationships between correction coefficients Ka and Kb and temperature.

FIG. 12 shows waveforms of a correction coefficient K, serial resistance Rs, laser drive current IL and laser light emission at each temperature.

FIG. 13 is an operational sequence diagram for the laser driving device according to the third embodiment of the present invention when the semiconductor laser is driven to emit light by a pulse having a width corresponding to a succession number of a digital signal NRZ.

FIG. 14 shows a waveform distortion that is generated when a width of a corrected pulse is increased.

FIG. 15 is an operational sequence diagram when a width of the corrected pulse that is added to the trailing pulse is set to the same value as a width of the trailing pulse.

FIG. 16 shows the main structure of a laser driving device according to another embodiment of the present invention.

FIG. 17 is a block diagram of a laser driving circuit according to a fourth embodiment of the present invention.

FIG. 18 shows the main structure of a laser driving circuit according to the fourth embodiment of the present invention.

FIG. 19 is an operational sequence diagram of the laser driving circuit according to the fourth embodiment of the present invention.

FIG. 20 is a table showing temperatures and constants of a high pass filter to be selected.

FIG. 21(a) shows an equivalent circuit of the semiconductor laser.

FIG. 21(b) is a graph showing the dependency of the serial resistance of the semiconductor laser on temperature.

FIG. 22 shows a relationship between temperature and light pulse waveform.

FIG. 23 shows the structure of a filter according to another embodiment of the present invention.

FIG. 24 shows the structure of a filter according to another embodiment of the present invention.

FIG. 25 shows the structure of a filter according to another embodiment of the present invention.

FIG. 26 shows the structure of a filter according to still another embodiment of the present invention.

FIG. 27 shows the main structure of a laser driving circuit according to another embodiment of the present invention.

FIG. 28 is a block diagram of a laser driving circuit according to a fifth embodiment of the present invention.

FIG. 29 shows the main structure of the laser driving circuit according to the fifth embodiment of the present invention.

FIG. 30 is a table showing resistances of the semiconductor laser and constants of a high pass filter to be selected.

FIG. 31 shows the main structure of a laser driving device of the background art.

### DESCRIPTION OF THE PREFERRED EMBODIMENTS

Hereinafter, preferred embodiments of the present invention will be described with reference to the attached drawings.

As embodiments of the present invention, laser driving devices will be mainly described, which can perform suitable pulse light emission even if a load is changed due to temperature variation.

Before explaining about the specific devices, a background to the invention that was carried out by the present inventors will be further described. It was found in a study by the present inventors that excessive or insufficient compensation in the conventional structure was caused by alteration of a load due to a temperature variation.

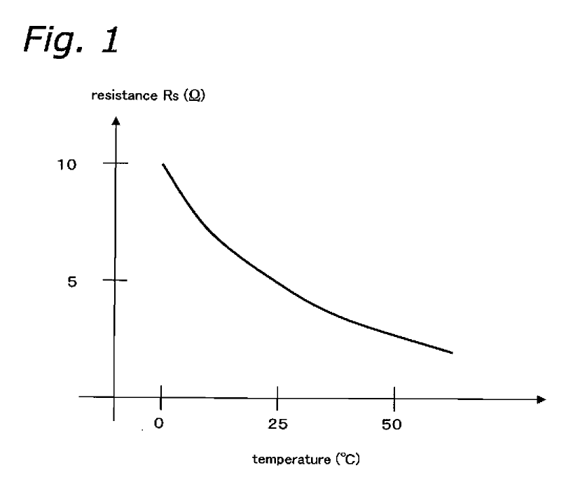

FIG. 1 shows an example of the variation of temperature with serial resistance in a red laser. As shown in FIG. 1, equivalent serial resistance (Rs) increases rapidly when the temperature falls to room temperature (=25 degrees centigrade) or less.

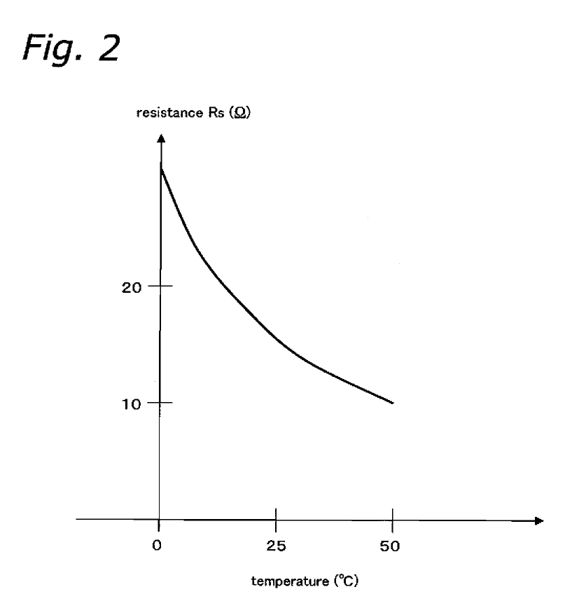

FIG. 2 shows an example of the variation of temperature with serial resistance in a blue laser that contains GaN as a main ingredient. As shown in FIG. 2, a blue laser has a high value of equivalent serial resistance (approximately 15-25 ohms, for example) due to its structure, and the value is substantially twice to four times the value of a red laser. In addition, the variation of the serial resistance with temperature is also larger than that of a red laser.

### First Embodiment

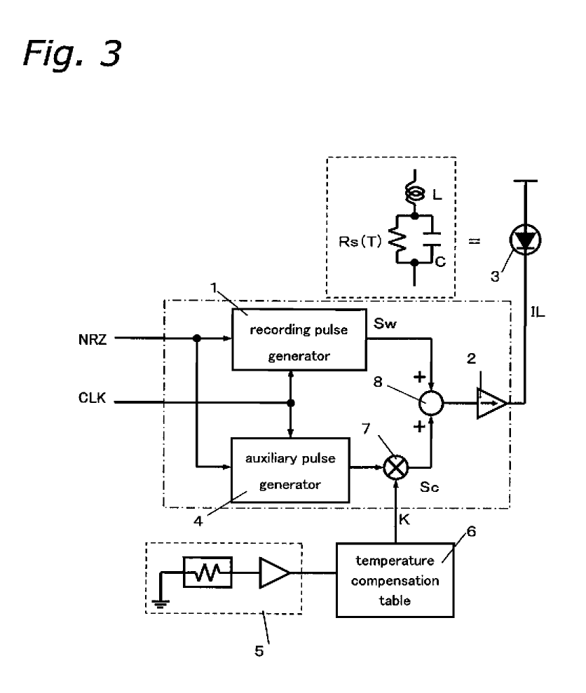

FIG. 3 is a block diagram of a laser driving device according to a first embodiment of the present invention. As shown in FIG. 3, a recording pulse generator 1 (a first pulse generation portion) generates a constant pulse signal Sw having a constant peak value in accordance with a digital signal (NRZ). Reference numeral 5 is a temperature sensor for measuring temperature and outputting the result as an electric signal. An auxiliary pulse generator 4, a temperature compensation table 6 and a variable gain amplifier 7 constitute a second pulse generation portion for generating a corrected pulse signal Sc having a peak value that changes in accordance with the measured temperature. Reference numeral 8 is an adder for adding the corrected pulse signal Sc to the constant pulse signal Sw, and the resulting signal is supplied to a semiconductor laser 3 via a current drive amplifier 2.

Note that, the recording pulse generator 1, the auxiliary pulse generator 4, the variable gain amplifier 7, the adder 8, and the temperature compensation table 6 constitute a pulse generation portion for outputting a pulse-like signal having a shape corresponding to a measured temperature.

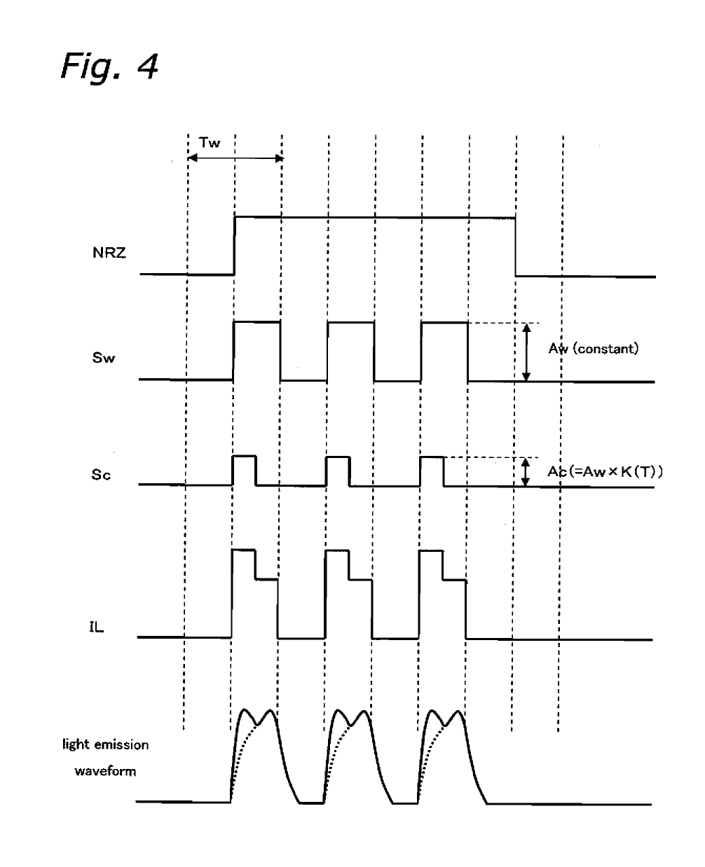

A digital signal NRZ supplied to the laser driving device in this embodiment is converted, by the recording pulse generator 1, into a multi-pulse signal (Sw) including at least a leading pulse and trailing pulses, which correspond to the number of successive digital signals “1” (hereinafter referred to as a succession number), as shown in FIG. 4. In the same manner, the auxiliary pulse generator 4 or the like generates the corrected pulse signal (Sc). A signal width thereof is smaller than a width of the leading pulse signal. FIG. 4 shows an example in which the interval between pulses is clock window Tw, and the pulse width is Tw/2. It is desirable that the pulse width of an auxiliary pulse signal be within the range of Tw/8-Tw/4, which will be described later. Here, it is set to Tw/4. In addition, the corrected pulse signal (Sc) is generated at a leading edge of the multi-pulse signal (Sw). As a result of this correction, a laser drive current IL having the waveform as shown in FIG. 4 is obtained. Consequently, a laser light emission waveform distorted by a laser load (shown by the dotted line in FIG. 4) is improved (as shown by the solid line in FIG. 4).

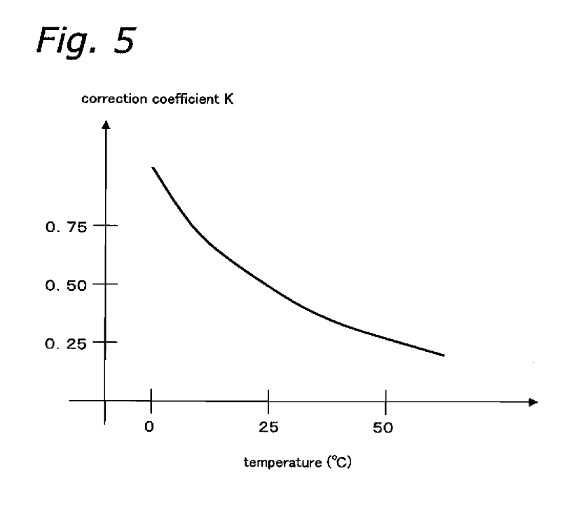

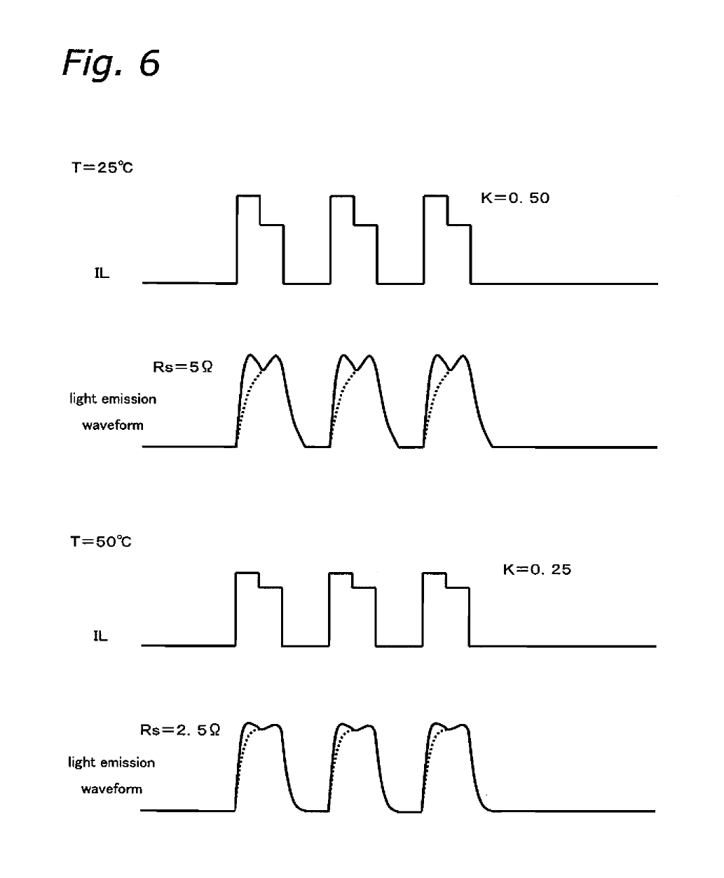

The present invention is characterized in that the correction coefficient is variable in accordance with temperature. Namely, the temperature compensation table 6 determines a coefficient K of the corrected pulse for a temperature measured by the temperature sensor 5, in accordance with the steadily decreasing relationship as shown in FIG. 5. A cause of this steady decrease is related to the temperature characteristic of the equivalent resistor Rs of the semiconductor laser 3 (it decreases as the temperature rises) as shown in FIG. 1. This coefficient K is multiplied by an output signal of the auxiliary pulse generator 4, so that the corrected pulse signal (Sc) is generated, in which a peak value changes in accordance with the measured temperature. For example, as shown in FIG. 6, it is supposed that an equivalent serial resistance Rs of the semiconductor laser is 5 ohms at the temperature T=25° C. and is 2.5 ohms at the temperature T=50° C. (see FIG. 1). Here, in order to compensate a waveform distortion due to a time constant defined by Rs=5 ohms, an equivalent load capacitance C and an inductance L at the temperature T=25° C., the correction coefficient K=0.5 is determined so that a rising time and an overshoot reach permissible values or less. On the other hand, in the case of T=50° C., the equivalent serial resistance Rs of the semiconductor laser decreases to 2.5 ohms, so the load viewed from the current drive amplifier 2 is reduced, and the distortion of the laser light emission waveform tends to be reduced. In this situation, if the drive current IL is supplied by K=0.5 that is the same as when T=25° C., the correction becomes excessive and go deterioration of the semiconductor laser may accelerate due to generation of the overshoot.

Therefore, in this embodiment, if the equivalent serial resistance Rs is decreased at a high temperature, the correction coefficient K is also decreased in accordance with the relationship shown in FIG. 5. As a result, the correction coefficient K becomes 0.25 at the temperature T=50° C., so that an appropriate laser light emission waveform can be obtained for a small load.

### Second Embodiment

A second embodiment of the present invention is an application of a recording and reproduction device that produces a light emission waveform having a width corresponding to a succession number of the digital signal NRZ. In this embodiment, a laser driving device is used that is to the same as that shown in FIG. 3 of the first embodiment.

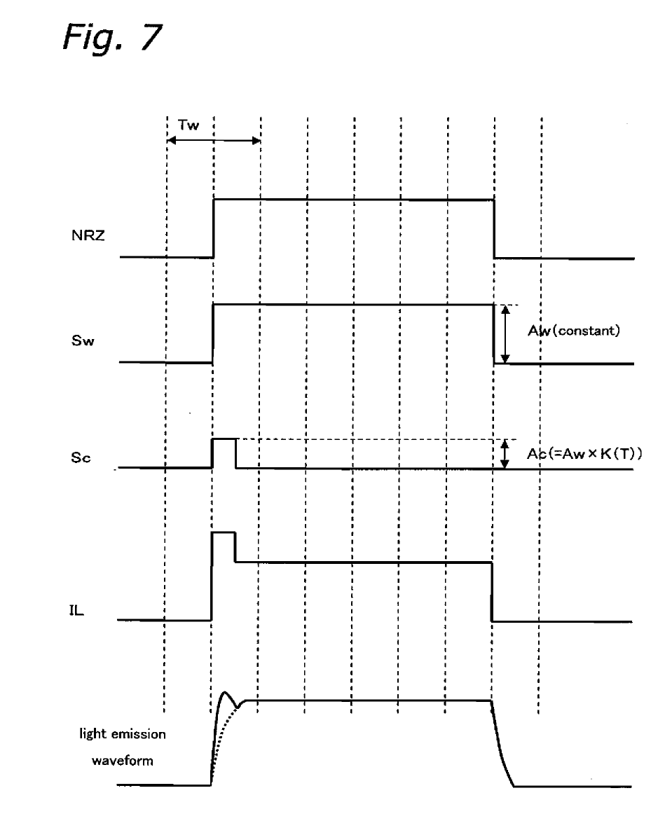

The digital signal NRZ supplied to the laser driving device in this embodiment is converted, by the recording pulse generator 1, into a pulse signal (Sw) having a width corresponding to a succession number of the digital signal “1”, as shown in FIG. 7.

In the same way, the auxiliary pulse generator 4 or the like generates the corrected pulse signal (Sc). A signal width thereof is smaller than a width of the pulse signal. FIG. 7 shows an example in which the interval between pulses is clock window Tw, and the pulse width is Tw/2. In this situation, it is desirable that the pulse width of an auxiliary pulse signal be within the range of Tw/8-Tw/4, which will be described later. Here, it is set to Tw/4. In addition, the corrected pulse signal (Sc) is generated at a leading edge of the pulse signal (Sw). As a result of this correction, a laser drive current IL having the waveform as shown in FIG. 7 is obtained. Consequently, a laser light emission waveform distorted by a laser load (shown by the dotted line in FIG. 7) is improved (as shown by the solid line in FIG. 7).

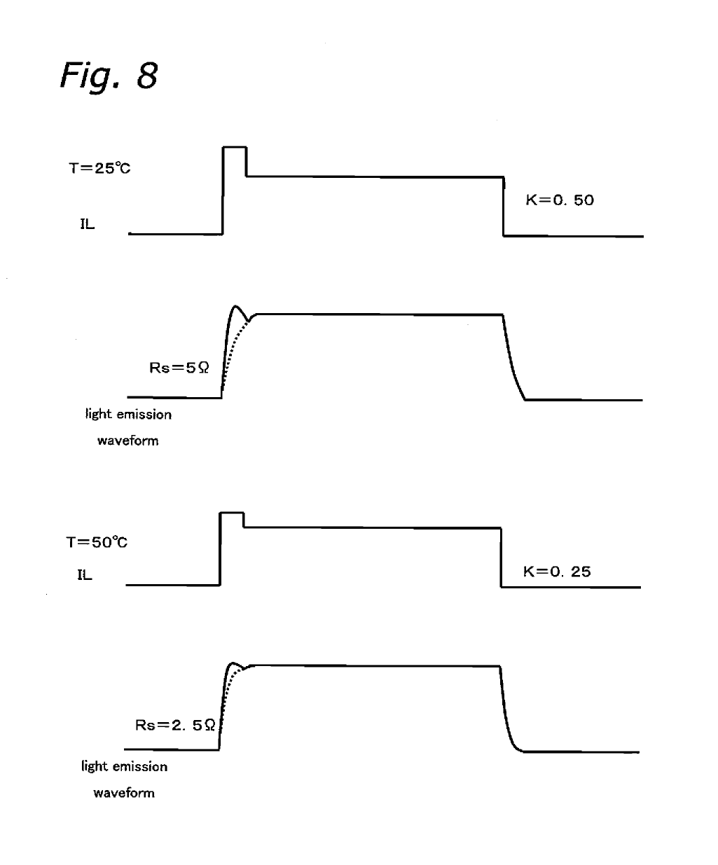

Similarly to the first embodiment, the temperature compensation table 6 determines a coefficient K of the corrected pulse for a temperature measured by the temperature sensor 5, in accordance with the steadily decreasing relationship as shown in FIG. 5. A cause of this steady decrease is related to the temperature characteristic of the equivalent resistor Rs of the semiconductor laser 3 (it decreases as the temperature rises) as shown in FIG. 1. This coefficient K is multiplied by an output signal of the auxiliary pulse generator 4, so that the corrected pulse signal (Sc) is generated, in which a peak value changes in accordance with the measured temperature. For example, as shown in FIG. 8, it is supposed that an equivalent serial resistance Rs of the semiconductor laser is 5 ohms at the temperature T=25° C. and is 2.5 ohms at the temperature T=50° C. (see FIG. 1). In this situation, in order to compensate a waveform distortion due to a time constant defined by Rs=5 ohms, an equivalent load capacitance C and an inductance L at the temperature T=25° C., the correction coefficient K=0.5 is determined so that a rising time and an overshoot reach permissible values or less. On the other hand, when T=50° C., the equivalent serial resistance Rs of the semiconductor laser decreases to 2.5 ohms, so the load viewed from the current drive amplifier 2 is reduced, and the distortion of the laser light emission waveform tends to be reduced. In this situation, if the drive current IL is supplied by K=0.5 that is the same as when T=25° C., the correction becomes excessive and so deterioration of the semiconductor laser may accelerate due to generation of the overshoot.

Therefore, in this embodiment, if the equivalent serial resistance Rs is decreased at a high temperature, the correction coefficient K is also decreased in accordance with the relationship shown in FIG. 5. As a result, the correction coefficient K becomes 0.25 at the temperature T=50° C., so that an appropriate laser light emission waveform can be obtained for a small load.

### Third Embodiment

A third embodiment of the present invention employs an auxiliary pulse generator B 9 for compensating a waveform distortion also at a trailing edge of the laser light emission waveform.

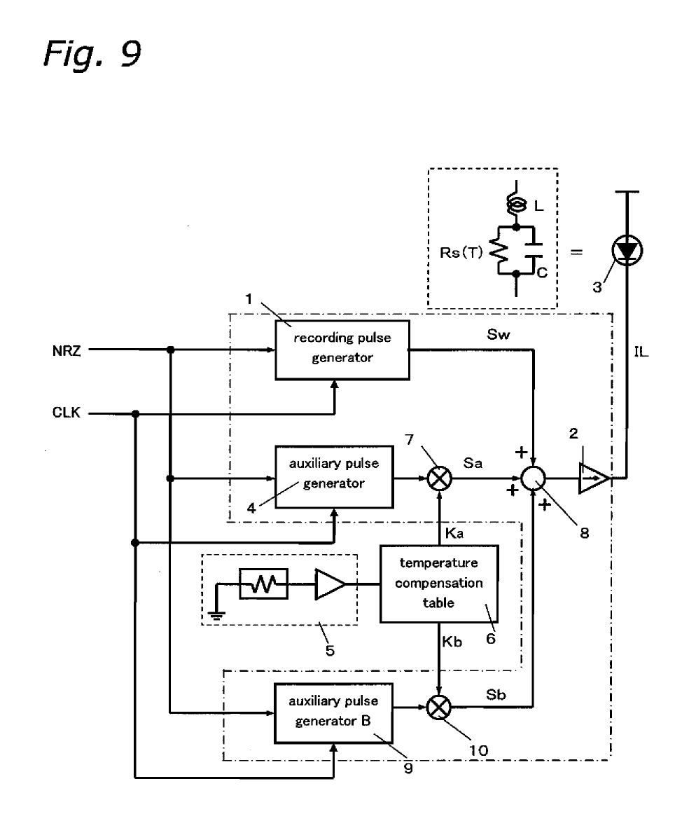

FIG. 9 is a block diagram of a laser driving device in accordance with the third embodiment. As shown in FIG. 9, similarly to the first embodiment, a recording pulse generator 1 (a first pulse generation portion) generates a constant pulse signal Sw having a constant peak value in accordance with a digital signal (NRZ). Reference numeral 5 is a temperature sensor for measuring temperature and outputting the result as an electric signal.

An auxiliary pulse generator 4, an auxiliary pulse generator B 9, a temperature compensation table 6 and a variable gain amplifier 7 and 10 constitute a second pulse generation portion for generating a corrected pulse signal having a peak value that changes in accordance with the measured temperature. In particular, An auxiliary pulse generator 4, a temperature compensation table 6 and a variable gain amplifier 7 constitute a third pulse generation portion for generating a corrected pulse signal Sa having a peak value that changes in accordance with the measured temperature. Further in this embodiment, the auxiliary pulse generator B 9, the temperature compensation table 6 and a variable gain amplifier 10 constitute a fourth pulse generation portion for generating a corrected pulse signal Sb having a peak value that changes in accordance with the measured temperature. Reference numeral 8 is an adder for adding the corrected pulse signals Sa and Sb to the constant pulse signal Sw, and the resulting signal is supplied to a semiconductor laser 3 via a current drive amplifier 2.

Note that, the recording pulse generator 1, the auxiliary pulse generator 4, the auxiliary pulse generator B 9, the variable gain amplifiers 7 and 10, the adder 8, and the temperature compensation table 6 constitute a pulse generation portion for outputting a pulse-like signal having a shape corresponding to measured temperature.

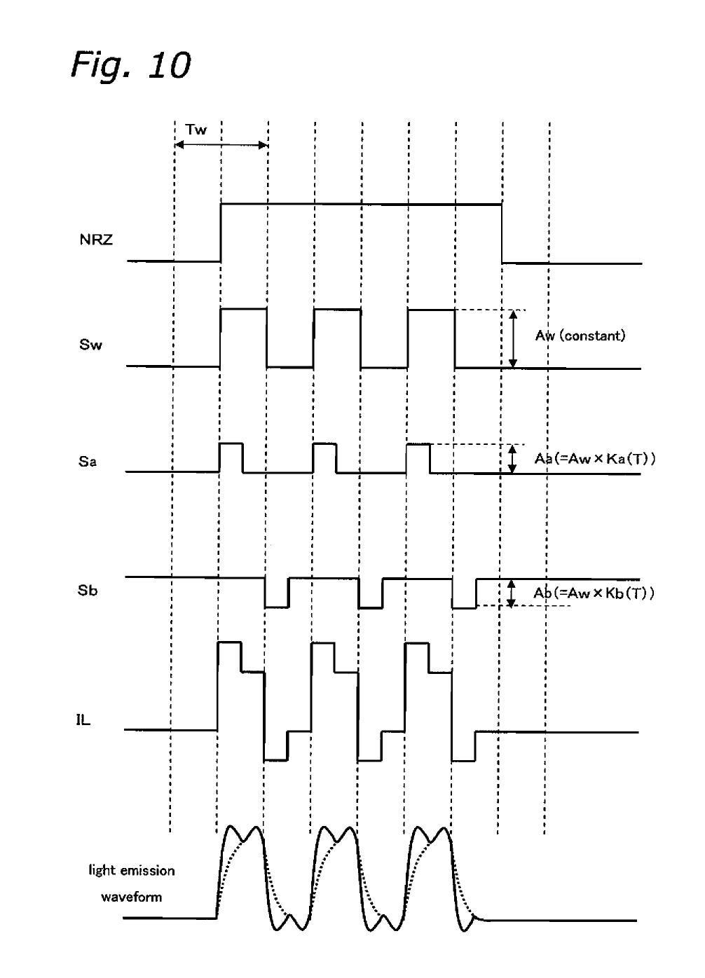

A digital signal NRZ supplied to the laser driving device in this embodiment is converted, by the recording pulse generator 1, into a multi-pulse signal (Sw) including at least a leading pulse and trailing pulses, which are a succession number of a digital signal “1”, as shown in FIG. 4. In the same manner, the auxiliary pulse generator 4 or the like generates the corrected pulse signal (Sa) on the basis of the leading edge of the multi-pulse signal Sw, and the auxiliary pulse generator B 9 or the like generates the corrected pulse signal (Sb) on the basis of the trailing edge of the multi-pulse signal Sw. The signal widths of these corrected pulse signals Sa and Sb are smaller than the width of the leading pulse signal. FIG. 10 shows an example in which the interval between pulses is clock window Tw, and the pulse width is Tw/2. It is desirable that the pulse width of an auxiliary pulse signal be within the range of Tw/8-Tw/4, which will be described later. Here, it is set to Tw/4. As a result of this correction, a laser drive current IL having the waveform as shown in FIG. 10 is obtained. Consequently, a laser light emission waveform distorted by a laser load (shown by the dotted line in FIG. 10) is improved (as shown by the solid line in FIG. 10).

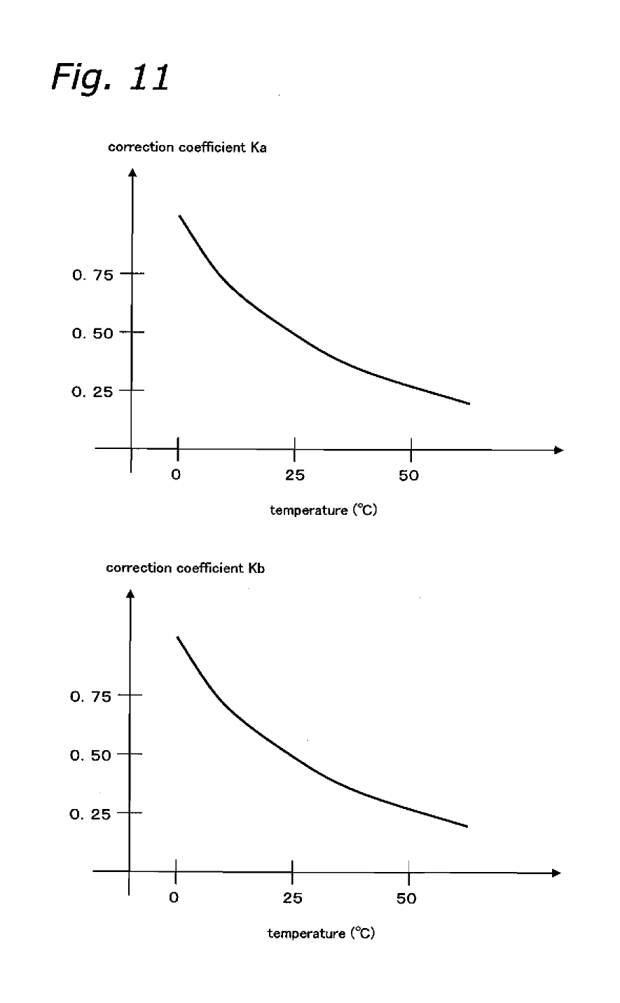

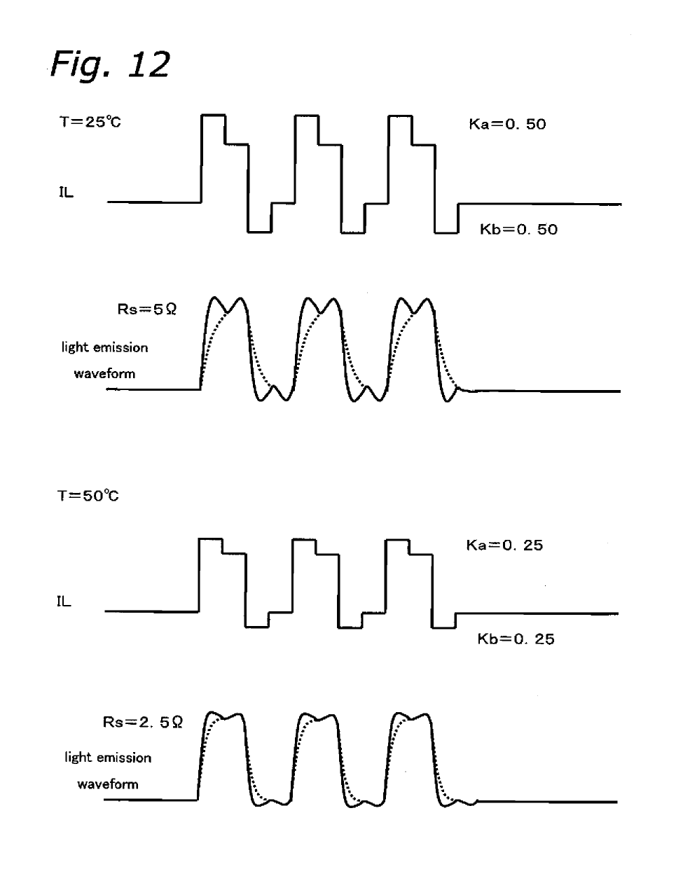

The present invention is characterized in that the correction coefficient is variable in accordance with temperature. Namely, the temperature compensation table 6 determines a coefficient Ka of a leading edge corrected pulse and a coefficient Kb of a trailing edge corrected pulse for a temperature measured by the temperature sensor 5, in accordance with the steadily decreasing relationship as shown in FIG. 11. A cause of this steady decrease is related to the temperature characteristic of the equivalent resistor Rs of the semiconductor laser 3 (it decreases as the temperature rises) as shown in FIG. 1. The coefficient Ka is multiplied by an output signal of the auxiliary pulse generator 4, so that the corrected pulse signal (Sa) is generated, in which a peak value changes in accordance with the measured temperature. Furthermore, the coefficient Kb is multiplied by an output signal of the auxiliary pulse generator B 9, so that the corrected pulse signal (Sb) is generated, in which a peak value changes in accordance with the measured temperature. For example, as shown in FIG. 12, it is supposed that an equivalent serial resistance Rs of the semiconductor laser is 5 ohms at the temperature T=25° C. and is 2.5 ohms at the temperature T=50° C. (see FIG. 1). In this situation, in order to compensate a waveform distortion due to a time constant defined by Rs=5 ohms, an equivalent load capacitance C and an inductance L at the temperature T=25° C., the correction coefficient Ka=0.5 is determined so that a rising time and an overshoot reach permissible values or less, and the correction coefficient Kb=0.5 is determined so that a falling time and an undershoot reach permissible values or less. On the other hand, when T=50° C., the equivalent serial resistance Rs of the semiconductor laser decreases to 2.5 ohms, so the load viewed from the current drive amplifier 2 is reduced, and the distortion of the laser light emission waveform tends to be reduced. In this situation, if the drive current IL is supplied by K=0.5 that is the same as when T=25° C., the correction becomes excessive and so deterioration of the semiconductor laser may accelerate due to generation of the overshoot.

Therefore, in this embodiment, if the equivalent serial resistance Rs is decreased at a high temperature, the correction coefficient Ka and Kb are also decreased in accordance with the relationships shown in FIG. 11. As a result, both the correction coefficients Ka and Kb become 0.25 at the temperature T=50° C., so that an appropriate laser light emission waveform can be obtained for a small load.

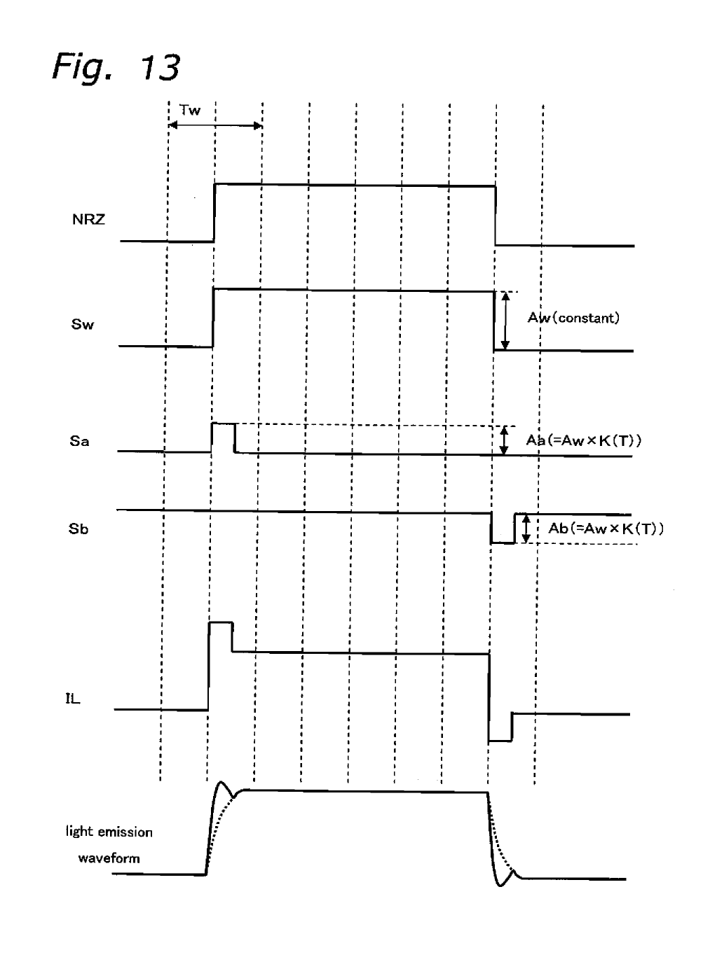

Note that, although the situation where the semiconductor laser is driven to emit light by a multi-pulse signal including a leading pulse and trailing pulses, which correspond to a succession number of the digital signal “1”, is exemplified for description of the third embodiment, the present invention can be applied to situations where the semiconductor laser is driven to emit light by a pulse having a width corresponding to a succession number of the digital signal NRZ, as shown in FIG. 13.

### Other Description about the First Through Third Embodiments

(1) Although it is described that the steadily decreasing relationship of the correction coefficient K (Ka and Kb in the third embodiment) is related to a temperature characteristic of the equivalent resistor Rs of the semiconductor laser 3 in the first through third embodiments, there are various methods to achieve this.

For example, it is possible to change an environmental temperature while the laser is driven to emit pulse light and to determine the correction coefficient K so that the rising time and the overshoot reach permissible values or less to obtain the relationship between the temperature and the correction coefficient K. Alternatively, it is possible to do the same experiment for a plurality of samples, so that a correction table includes a relationship between a typical temperature and a correction coefficient K. In addition, where the temperature characteristic of the equivalent resistor Rs is a function Rs(T) of the temperature T, the following equation may be satisfied so that the correction coefficient K has a component that is proportional to this Rs(T).

K(T)=α1×Rs(T)+β1

Here, α1 and β1 are constants. In addition, if the equivalent resistor Rs has an inversely proportional relationship to the temperature, the following equation may be satisfied.

K(T)=α2/T+β2

Here, α2 and β2 are constants.

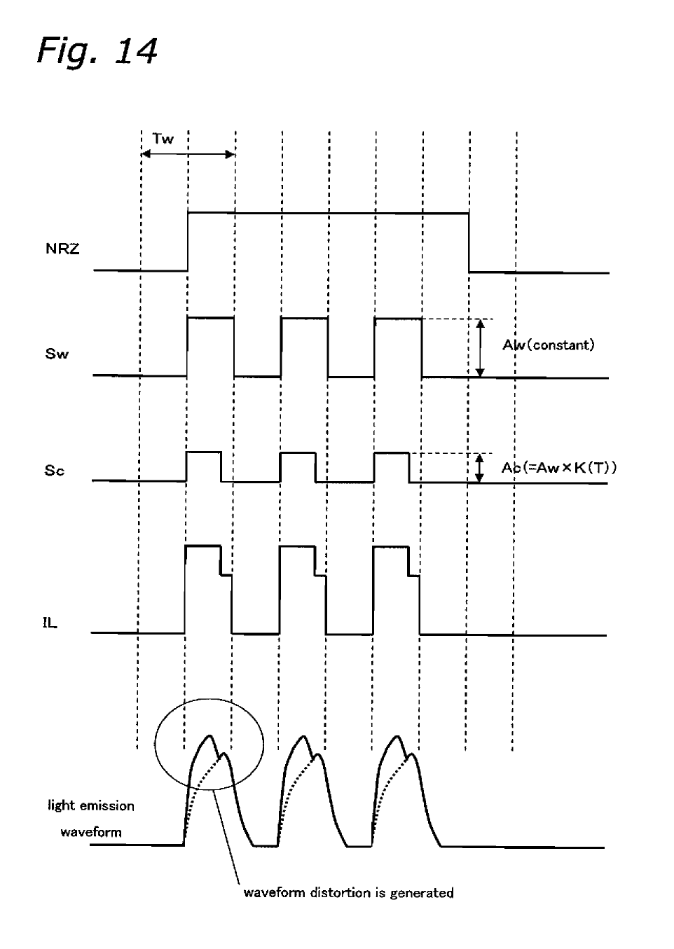

(2) There is a reason why the pulse width of the auxiliary pulse signal is smaller than the width of the leading pulse and is within the range of Tw/8-Tw/4 in the first and the third embodiments. If the pulse width of the auxiliary pulse signal is too small, the waveform distortion cannot be corrected. Therefore, the pulse width should be more than or equal to Tw/8. In addition, if the pulse width is too large, the correction may be excessive resulting in generation of a waveform distortion as shown in FIG. 14. In order to avoid this waveform distortion, it is preferable that the pulse width be less than or equal to the leading pulse width, more preferably less than or equal to Tw/4.

Note that this is merely an example, and the pulse width of the auxiliary pulse signal can be selected freely as long as it is less than or equal to the width of the leading pulse.

In addition, the pulse width of the auxiliary pulse signal is set to a smaller value than that of the constant pulse signal Sw, to be within the range of Tw/8-Tw/4 for the same reason as described above in the second embodiment. If the pulse width of the auxiliary pulse signal is too small, the waveform distortion cannot be corrected. Therefore, the pulse width should be more than or equal to Tw/8. In addition, if the pulse width is too large, the correction may be excessive resulting in generation of a waveform distortion. In order to avoid this waveform distortion, it is preferable that the pulse width be less than or equal to the leading pulse width, more preferably less than or equal to Tw/4.

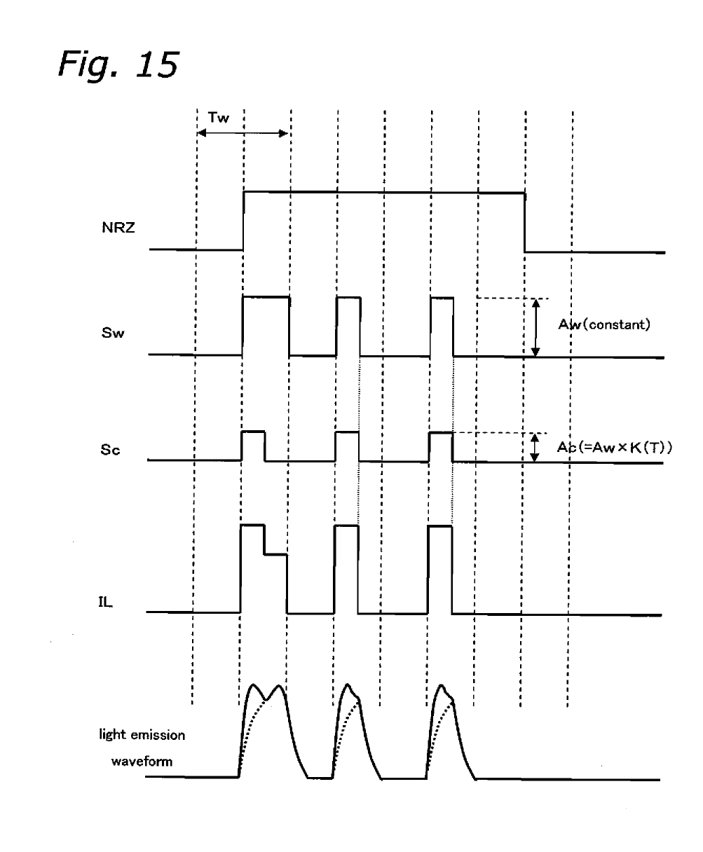

In addition, as shown in FIG. 15, if a width of the trailing pulse is small compared with the leading pulse, it is preferable that a width of the corrected pulse to be added to the trailing pulse be made equal to the width of the trailing pulse, so that the waveform distortion can be corrected appropriately. In this situation, there is no need to employ means for changing the pulse width of the auxiliary pulse, and the structure of the device can be simplified.

(3) Although the first through third embodiments describe driving a red laser, the present invention is not limited to this.

As shown in FIG. 2, the equivalent serial resistance is large in a blue laser containing GaN as a main ingredient, and the value is substantially twice to four times the value for a red laser. Therefore it is expected that a waveform distortion phenomenon due to a high equivalent serial resistance at low temperature may be conspicuous. The present invention can also obtain the effect when applied to the case where such a blue laser is modified.

(4) It is described in the first through third embodiments that the coefficient K of the corrected pulse is determined from the temperature compensation table 6 in accordance with a measured value that is measured by using a temperature sensor.

Here, the temperature measured by the temperature sensor is preferably the temperature of the semiconductor laser, but it can be the temperature of the environment where the semiconductor laser is placed.

Furthermore, the coefficient K of the corrected pulse can be determined in accordance with a measured value other than temperature.

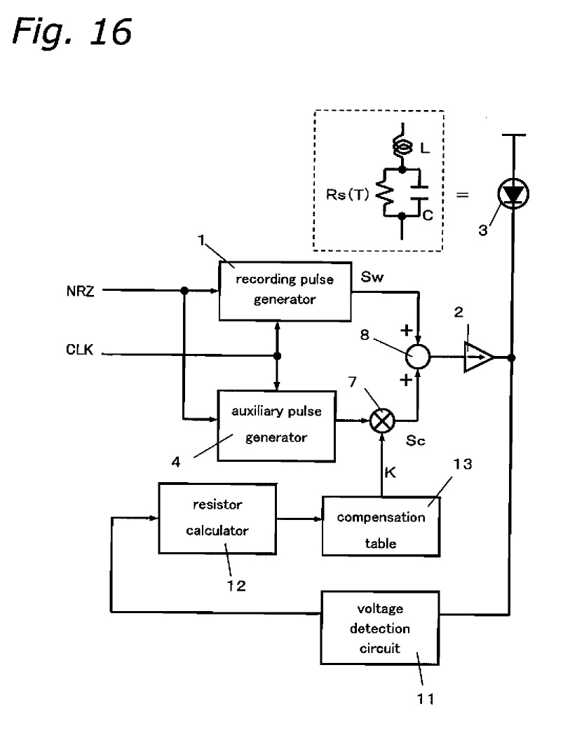

FIG. 16 shows an example. As shown in FIG. 16, there are means for determining the coefficient K of the corrected pulse in accordance with a resistance that is calculated from an operating voltage of the semiconductor laser, instead of the temperature sensor 5 and the temperature compensation table 6 that were described with reference to FIG. 3. In FIG. 16, the same reference numerals are used for the same elements as in FIG. 3. Hereinafter, portions that are different from those in FIG. 3 will be mainly described.

The laser driving device shown in FIG. 16 includes a voltage detection circuit 11, a resistor calculator 12 and a compensation table 13. The voltage detection circuit 11 is connected to the current drive amplifier 2 so as to measure the operating voltage of the semiconductor laser. The resistor calculator 12 calculates the resistance of the semiconductor laser from the operating voltage detected by the voltage detection circuit 11 and the operation current of the semiconductor laser. The compensation table 13 includes coefficients K of the corrected pulse for resistance values, so as to output a coefficient K of the corrected pulse corresponding to the calculated resistance. Here, the table included in the compensation table 13 includes a coefficient K that increases steadily with the resistance.

Note that it is not necessary that the voltage detection circuit 11 and the resistor calculator 12 are made of separate portions, but may be a device that can obtain a resistance of the semiconductor laser directly.

In addition, the compensation table 13 may include values of coefficient K of the corrected pulse for voltage values, so as to output a coefficient K directly for a voltage detected by the voltage detection circuit 11.

(5) Each functional block in the block diagram or hardware structure is typically realized as an LSI, that is, an integrated circuit. The functional blocks may be employed in separate chips, or a whole or a part of them may be included in a single chip.

For example, the recording pulse generator 1, the auxiliary pulse generator 4, the adder 8, the variable gain amplifier 7, and the current drive amplifier 2 shown in FIG. 3 can be integrated in a single chip (within the alternating long and short dashed line in FIG. 3).

In addition, the recording pulse generator 1, the auxiliary pulse generator 4, the adder 8, the variable gain amplifier 7, the auxiliary pulse generator B 9, the variable gain amplifier 10, and the current drive amplifier 2 shown in FIG. 9 can be integrated in a single chip (within the alternating long and short dashed line in FIG. 9), for example.

Although the term “LSI” is used, it may be called an IC, a system LSI, a super LSI, or an ultra LSI, depending on its integration.

In addition, the method of integration is not limited to LSI, but it can be achieved by a special-purpose circuit or a general-purpose processor. It is also possible to utilize an FPGA (Field Programmable Gate Array) that can be programmed after the manufacturing process of the LSI, or a reconfigurable processor that can be restructured with respect to the connection or setting of circuit cells in the LSI.

Furthermore, if a new technology for circuit integration that can replace the existing LSI technology appears as a developing semiconductor technology or another derived technology, the new technology may be used for integrating the functional blocks. Application of biotechnology also has such potential.

### Fourth Embodiment

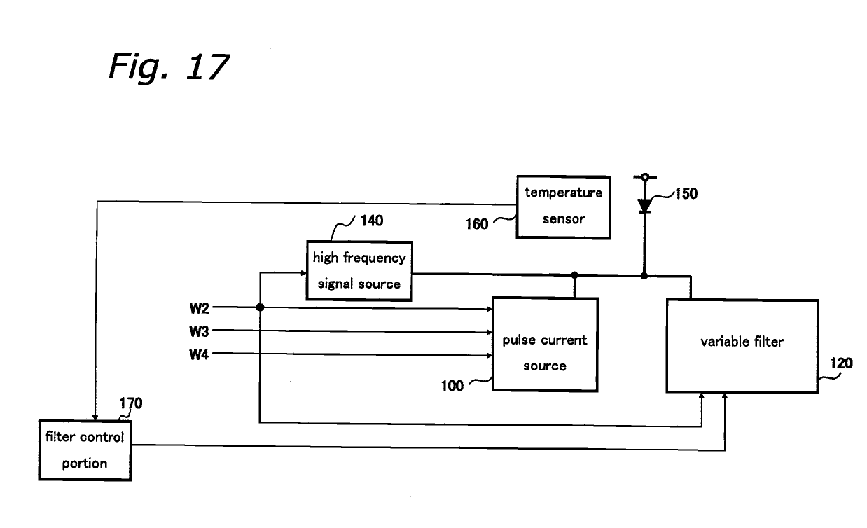

FIG. 17 is a block diagram of a laser driving circuit according to a fourth embodiment of the present invention. The laser driving circuit of the present invention includes a pulse current source 100 for supplying a pulse current to a semiconductor laser 150 as a recording signal, a high frequency signal source 140 for supplying a high frequency current to the semiconductor laser, a variable filter 120 for performing a waveform equalization of the semiconductor laser, a temperature sensor 160 for measuring a temperature and a filter control portion 170 for controlling a constant of the variable filter.

Note that the pulse current source 100 and the variable filter 120 constitute the pulse generation portion for outputting a pulse-like signal having a shape corresponding to a measured temperature.

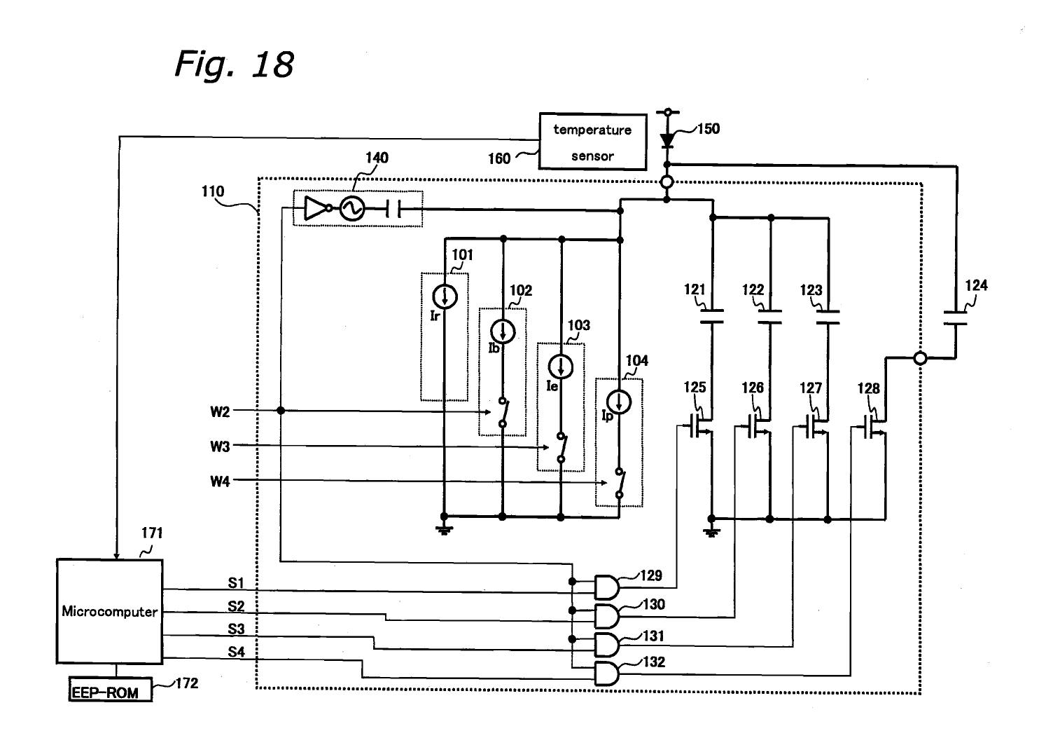

The main structure of a more detailed laser driving circuit will now be described with reference to FIG. 18. In FIG. 18, the laser driving circuit 110 enclosed by a dotted line is an integrated circuit.

In FIG. 18, reference numerals 101-104 are current sources for driving the semiconductor laser 150 to emit light with the desired light intensity. The current source 101 supplies a current Ir to the semiconductor laser.

In addition, the current source 102 supplies a current Ib in accordance with a recording signal W2. In the same manner, the current source 103 supplies a current Ie in accordance with a recording signal W3, while the current source 104 supplies a current Ip in accordance with a recording signal W4.

The high frequency signal source 140 supplies the high frequency current to be added to the DC current Ir so as to suppress a so-called scoop noise that is generated when light reflected by the optical disk returns to the semiconductor laser in the information reproducing mode.

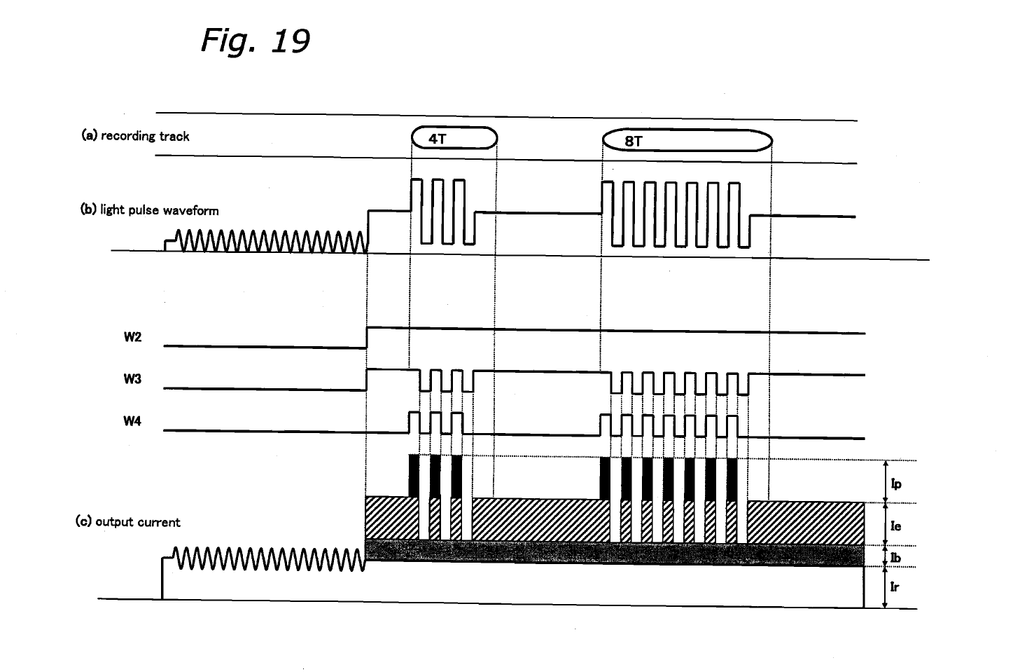

Here, operation sequences of the information reproducing mode and the information recording mode will be described with reference to FIG. 19. In the reproducing mode, only the current source 101 among the current sources 101-104 supplies a current to the semiconductor laser 150, because the recording signals W2-W4 are L level. Furthermore, the high frequency current from the high frequency signal source 140 is added.

In the information recording mode, the following operation is performed. When forming recording marks and recording spaces as shown in FIG. 19(a) on a recording track, it is necessary to irradiate a light pulse train, which is modulated by a peak level, a bottom level and a bias level, as shown in FIG. 19(b), onto a recording film. For this reason, the currents Ir, Ib, Ie and Ip are summed to generate a pulse current as shown in FIG. 19(c) in accordance with the recording signals W2-W4, and the pulse current is supplied to the semiconductor laser. By this operation, a light pulse modulated to a desired intensity is generated, as shown in FIG. 19(b).

In addition, capacitors 121-124 and MOS transistors 125-128 constitute high pass filters for optimizing the light pulse waveform. The light pulse waveform becomes a waveform with a ringing due to the influence of inductance of a wire between the semiconductor laser 150 and the laser driving circuit 110. In order to suppress this ringing and to obtain an appropriate light pulse waveform, the above filter is provided.

When capacitances of the capacitors 121, 122, 123 and 124 are C1, C2, C3 and C4, each of C2-C4 satisfies the following equations.

C2=2×C1

C3=4×C1

C4=8×C1

If C1=5 picofarads here for example, C2=10 picofarads, C3=20 picofarads, and C4=40 picofarads. With this structure, a constant Cc of the high pass filter can be selected from sixteen values from the range of 0-75 picofarads by a resolution of 5 picofarads. This selection is performed by controlling ON and OFF of MOS switches 125-128 in accordance with signals S1-S4.

Note that if a high pass filter works in the reproducing mode, amplitude of the high frequency current to be added decreases, so that returning light noise may increase, resulting in a drop in reproduction performance of the optical disk device. Therefore, in order to prevent the capacitors 121-124 from working as the high pass filters in the reproducing mode, all the MOS switches are turned off by AND gate 129-132, regardless of logic levels of selecting signals S1-S4 when the recording signal W2 is L level (i.e., in the reproducing mode).

Note that a capacitor 124 of the largest capacitance is disposed outside of the integrated circuit so as to reduce a chip area of the integrated circuit in this example.

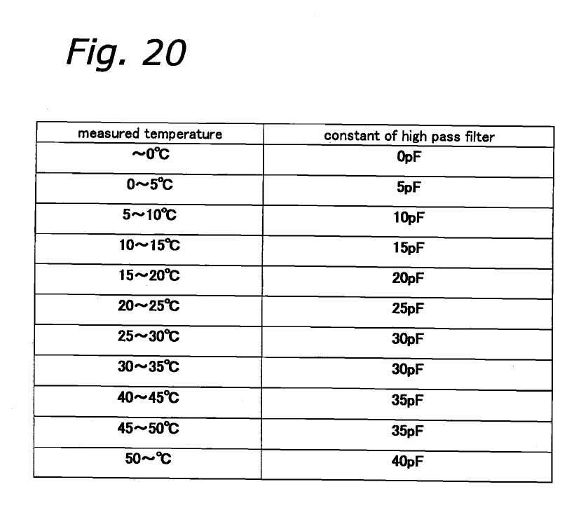

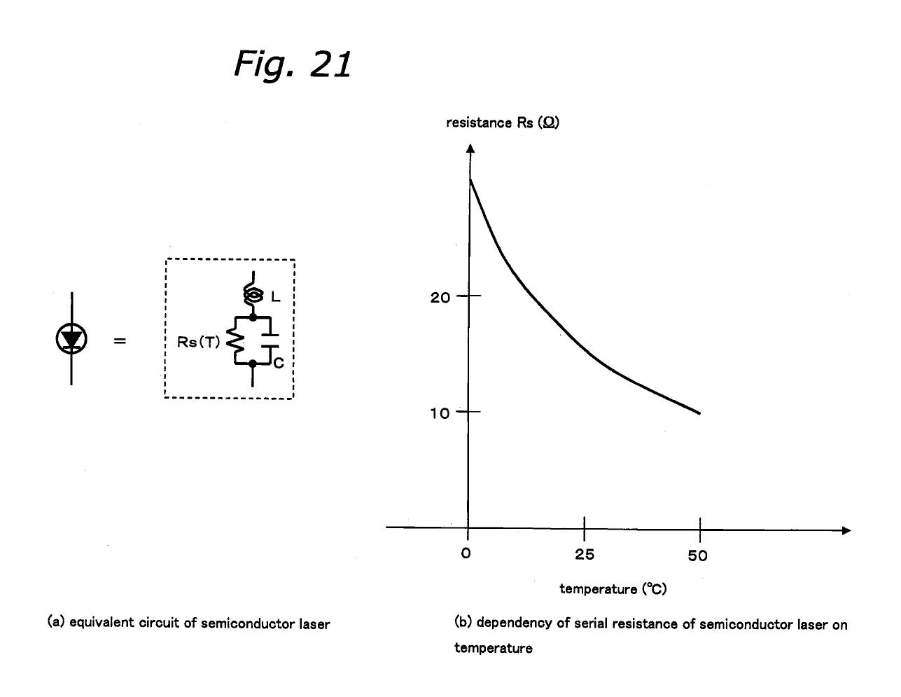

The present invention is characterized in that the constant Cc of the high pass filter is changed in accordance with temperature. An EEPROM 172 stores a characteristic table of the constant (Cc) of the high pass filter that can obtain an optimal light pulse waveform for temperatures measured by the temperature sensor, as shown in FIG. 20. The table is defined so that the constant Cc of the high pass filter increases as the temperature rises. In this table, the serial resistance Rs in the equivalent circuit of the semiconductor laser 150 shown in FIG. 21(a) is related to the temperature characteristic shown in FIG. 21(b) (it decreases as the temperature rises). A microcomputer 171 looks up the table stored in the EEPROM 172 for selecting the constant Cc of the high pass filter corresponding to a temperature measured by the temperature sensor, so that logic levels of the signals S1-S4 can be determined for controlling the MOS switches 125-128.

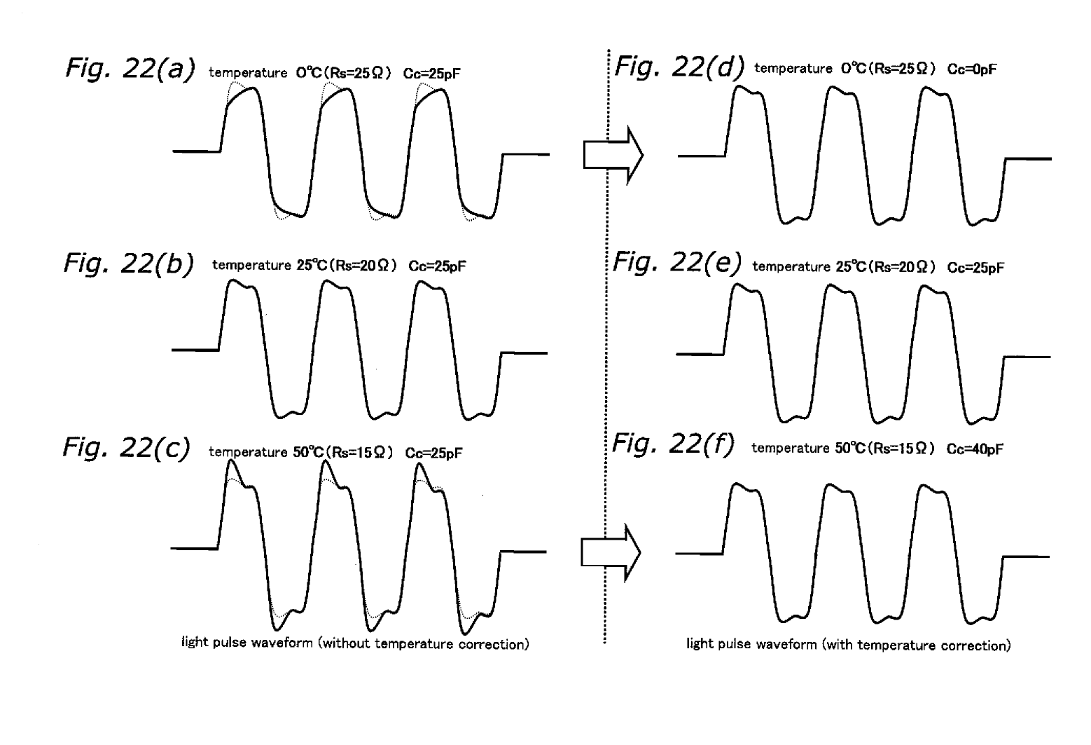

For example, as shown in FIG. 22, it is supposed that the serial resistance Rs of the semiconductor laser is 20 ohms when the temperature T=25° C. (see FIG. 21(b)). In this situation, in order to compensate the ringing of the light pulse waveform due to a time constant (that is determined by the equivalent circuit of the semiconductor laser as shown in FIG. 21(a), i.e., Rs=20 ohms,) the capacitance C and the inductance L at T=25° C., the constant of the high pass filter is selected as Cc=25 picofarads so that the rising time and the overshoot reach permissible values or less. On the other hand, in the case of T=0° C., the serial resistance Rs of the semiconductor laser drops to 30 ohms. Therefore, if the constant of the high pass filter is the same as for when T=25° C., the light pulse waveform is distorted notably, as shown in FIG. 22(a). Furthermore, when T=50° C., the serial resistance Rs of the semiconductor laser drops to 15 ohms. Therefore, if the constant of the high pass filter is the same as for when T=25° C., the overshoot of the light pulse waveform increases, as shown in FIG. 22(c). Temperature variation of the light pulse waveform may cause quality deterioration of the recording signal.

Therefore, in this embodiment, if the equivalent serial resistance Rs is increased at a low temperature, the constant of the high pass filter is decreased to Cc=0 picofarads. In addition, if the serial resistance Rs is decreased at a high temperature, the constant of the high pass filter is increased to Cc=40 picofarads. As a result, an appropriate light pulse waveform can be obtained, in which the overshoot is controlled within a permissible range either at a low temperature or at a high temperature, as shown in FIGS. 22(d) and 22(f).

Note that although the capacitors 121-123 are included in the integrated circuit and the capacitor 124 is disposed at the outside of the integrated circuit in this embodiment, the present invention is not limited to this. If the integrated circuit has sufficient area, all the capacitors may be included in the integrated circuit.

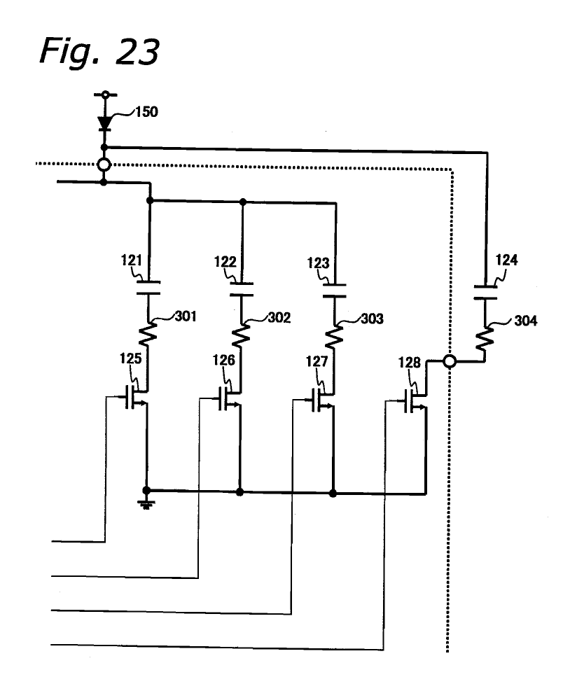

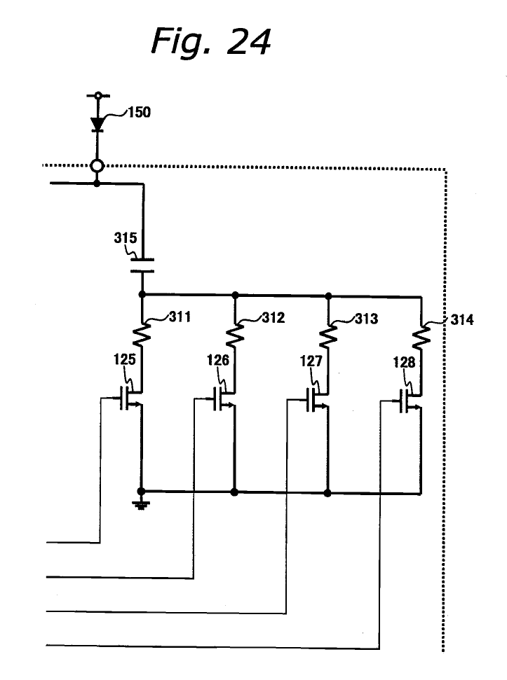

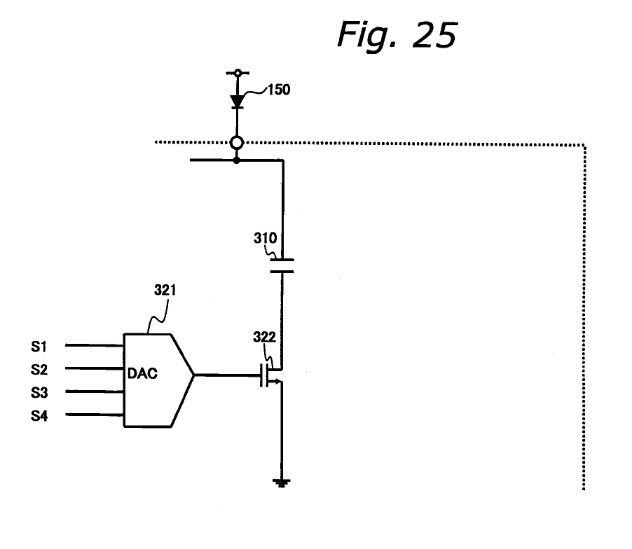

In addition, although the high pass filter is made up of a capacitor in this embodiment, the present invention is not limited to this. For example, the high pass filter may be made up of a capacitor and a resistor connected in series as shown in FIG. 23 to obtain the same effect. In addition, as shown in FIG. 24, the high pass filter may include a capacitor connected to a plurality of combinations each of which includes a resistor and a MOS switch, and a characteristic value of the filter may vary along with the resistance (which is variable) by the operation of the MOS switches 125-128. In addition, as shown in FIG. 25, a characteristic value of the high pass filter may vary along with an on-resistance of MOS switch 322 whose gate voltage is controlled by an output voltage of a DA converter 322.

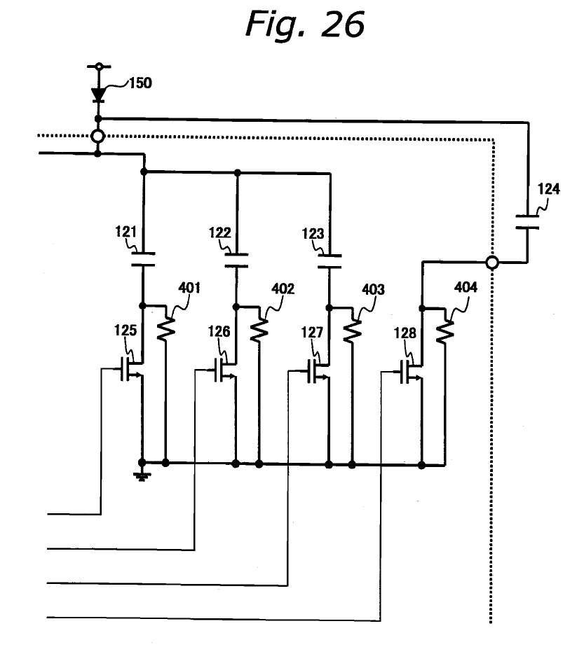

In addition, a rapid current may flow for charging a capacitor at the moment when at least one of the MOS switches 125-128 is turned on. This current is supplied from an anode power source of the semiconductor laser and flows into the laser, so there is a possibility of breakdown of the laser. In order to avoid this breakdown, it is preferable to connect pull-down resistors 401-404 at nodes between capacitors and MOS switches as shown in FIG. 26.

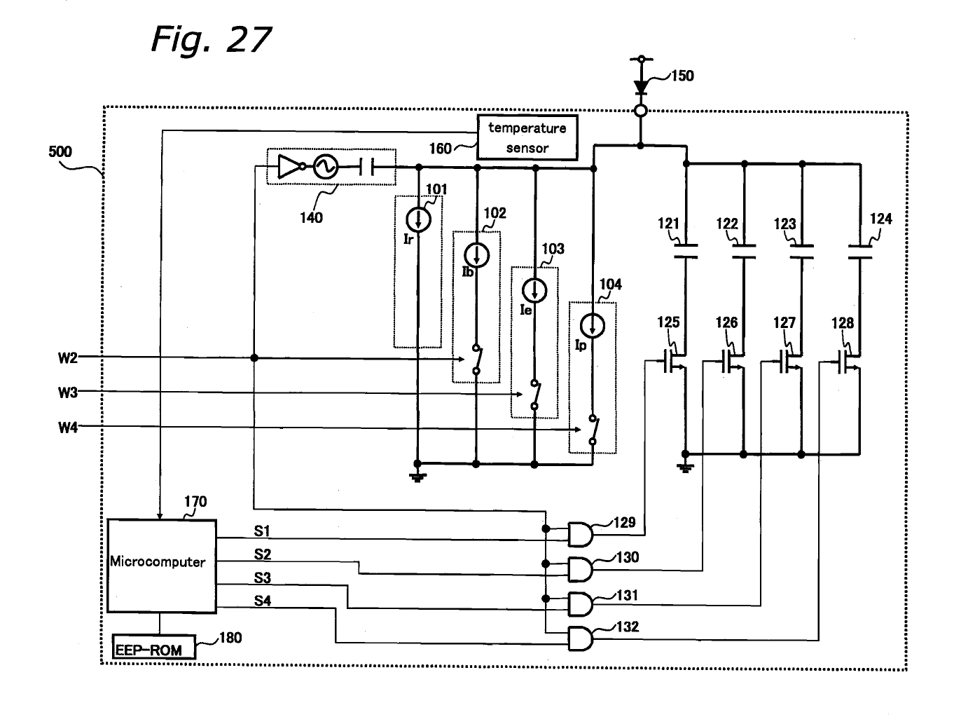

In addition, though the laser driving circuit 110 enclosed by the dotted line in FIG. 18 is an integrated circuit in this embodiment, the present invention is not limited to this. For example, if the temperature sensor, the microcomputer and the EEPROM are included in the integrated circuit as shown in FIG. 27, the number of components on the pickup can be reduced so that a low cost can be achieved. In addition, the number of signals can be reduced so that the pickup can be simplified. In addition, the above description (5) in (Other description about the first through third embodiments) can be repeated for this embodiment.

### Fifth Embodiment

A fifth embodiment has the structure in which the serial resistance Rs of the semiconductor laser is calculated directly from the operating voltage and the drive current of the semiconductor laser, and the constant Cc of the high pass filter is changed in accordance with the serial resistance Rs so as to control the light waveform in an optimal manner.

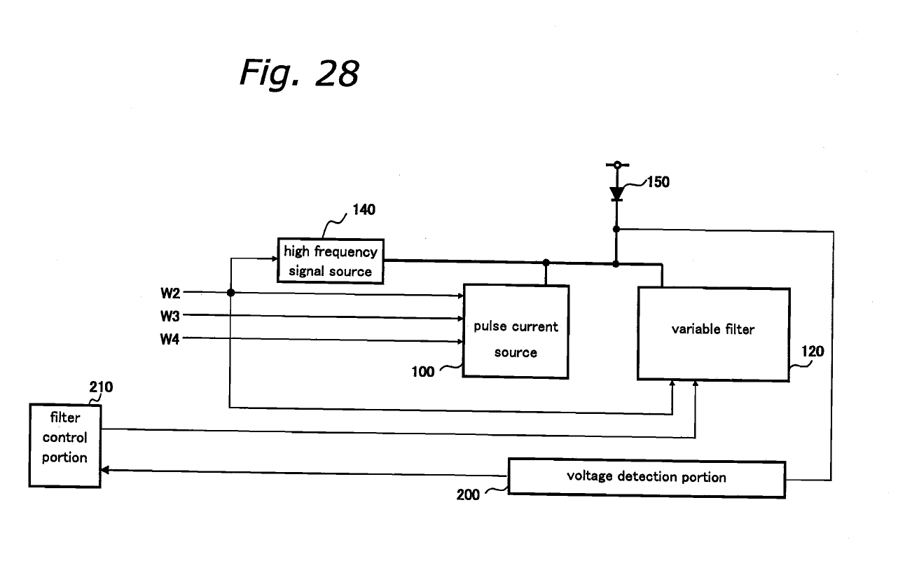

FIG. 28 is a block diagram of a laser driving circuit according to the fifth embodiment of the present invention. The laser driving circuit of the present invention includes a pulse current source 100 for supplying a pulse current to the semiconductor laser 150 in accordance with a recording signal, a high frequency signal source 140 for supplying a high frequency current to the semiconductor laser 150, a variable filter 120 for performing waveform equalization of the laser, a voltage detection circuit 200 for detecting an operating voltage of the semiconductor laser, and a filter control portion 210 for controlling a constant of the variable filter.

Note that the pulse current source 100 and the variable filter 120 constitute the pulse generation portion for outputting a pulse-like signal having a shape corresponding to the operating voltage.

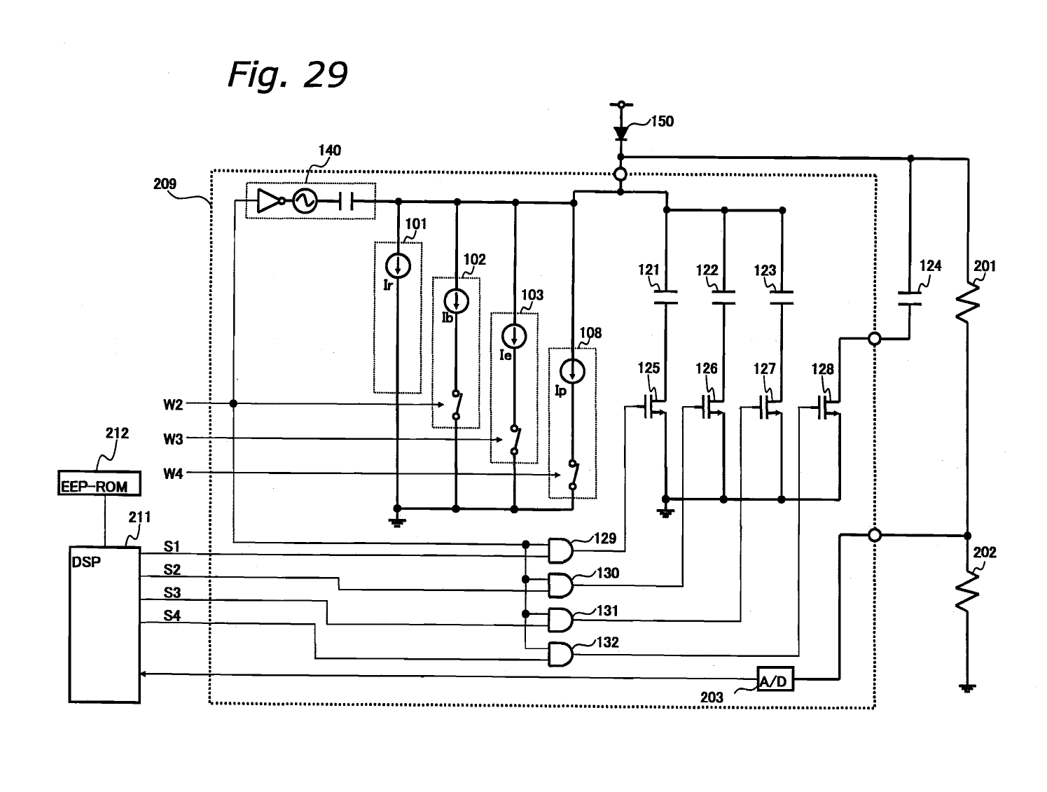

A more detailed structure of the laser driving circuit will now be described with reference to FIG. 29. In FIG. 29, the same reference numerals are used for the same elements as in FIG. 18 so as to omit descriptions thereof.

As shown in FIG. 29, an A/D converter 203 and resistors 201 and 202 constitute a detection circuit for the operating voltage of the semiconductor laser. The resistors 201 and 202 divide an output voltage Vout of the laser driving circuit. If resistance values of the resistors 201 and 202 are equal to each other (10 kilohms, for example), a detected voltage Vdet of the A/D converter is as follows.

Vdet=Vout/2 (Equation 1)

On the other hand, an operating voltage Vop of the semiconductor laser is derived by the following equation when a power source voltage at an anode of the semiconductor laser is E.

Vop=E−Vout (Equation 2)

Therefore, the following equation is derived from (Equation 1) and (Equation 2).

Vop=E−2×Vdet (Equation 3)

Thus, the operating voltage of the semiconductor laser can be obtained by detecting the voltage Vdet.

Furthermore, an operating DSP 211 determines a serial resistance Rs of the semiconductor laser from the detected voltage and the drive current. For example, the operating voltage Vb is detected when the semiconductor laser is driven in a DC light emission mode by a bottom power, and further the operating voltage Ve is detected when semiconductor laser is driven in a DC light emission mode by a bias power. Then, a difference ΔVop of the operating voltage between the bottom power and the bias power is calculated by the following equation.

ΔVop=Ve−Vb

In addition, the drive current ΔIop between the bottom power and the bias power is as follows.

ΔIop=Ie

Therefore, the serial resistance Rs of the semiconductor laser can be calculated as follows.

Rs=ΔVop/ΔIop

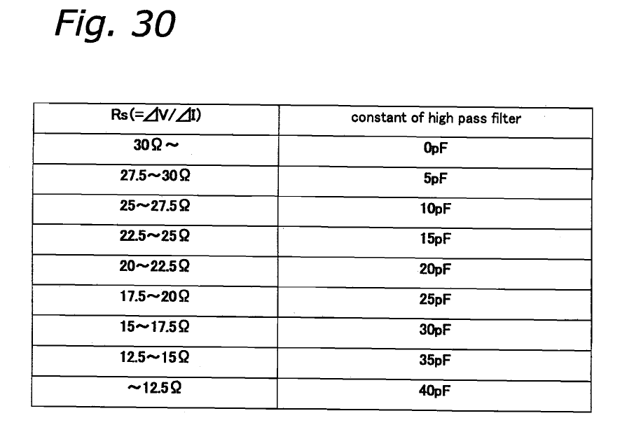

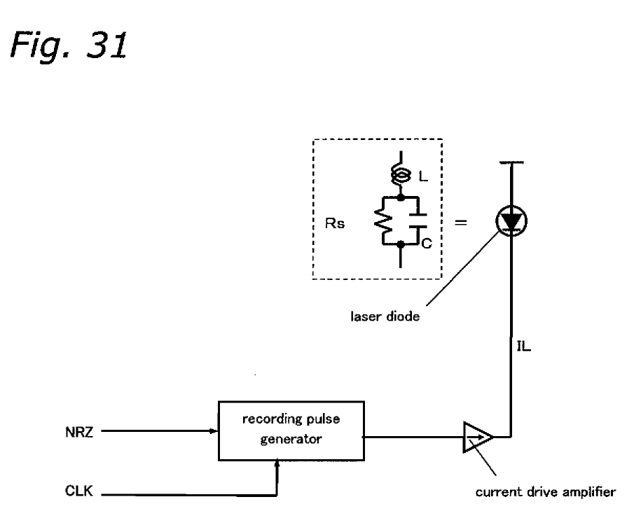

An EEPROM 212 stores a characteristic table of the constant of the high pass filter that can obtain an optimal light pulse waveform for the varying serial resistance Rs of the semiconductor laser, as shown in FIG. 30. An operating DSP looks up the EEPROM so as to select a constant Cc of the high pass filter that is most favorable for the serial resistance Rs of the semiconductor laser.

According to this structure, an appropriate light pulse waveform can be obtained in which an overshoot is controlled within a range of permissible values, even if the serial resistance Rs of the semiconductor laser changes due to a variation of temperature. Namely, the light emission power of the semiconductor laser can be corrected in accordance with resistance of the semiconductor laser.

### Other Description about the Fourth and the Fifth Embodiments

(1) The variations described in the first through fifth embodiments can be used after combining them if necessary. For example, a structure for detecting the operating voltage of the semiconductor laser described in the fifth embodiment can be applied to the laser driving device described with reference to FIG. 16.

The laser driving device according to the present invention has a good pulse light emission characteristic that is independent of temperature and is useful for a recording and reproduction device of a DVD.

1. A laser driving device for driving a semiconductor laser to emit light in a pulse-like manner in accordance with a digital signal, the laser driving device comprising:
a measurement unit operable to produce a measured value that changes in accordance with a temperature of the semiconductor laser; and
a pulse generation unit operable to produce a pulse-like signal having a shape corresponding to the measured values
wherein the pulse generation unit includes a first pulse generation portion for generating a first pulse signal having a constant peak value, a second pulse generation portion for generating a second pulse signal having a peak value that changes in accordance with the measured value, and an adder for adding the second pulse signal to the first pulse signal so as to produce the pulse-like signal.

2. The laser driving device according to claim 1, wherein the measurement unit is a device for measuring the temperature of the semiconductor laser.

3. The laser driving device according to claim 1, wherein the measurement unit is a device for measuring a voltage or a resistance of the semiconductor laser.

4. (canceled)

5. The laser driving device according to claim 1, wherein the second pulse generation portion includes a third pulse generation portion for generating a third pulse signal that is a forward direction signal with respect to the first pulse signal and has a peak value that changes in accordance with the measured value, and a fourth pulse generation portion for generating a fourth pulse signal that is a reverse direction signal with respect to the first pulse signal and has a peak value that changes in accordance with the measured value.

6. The laser driving device according to claim 1, wherein the measurement unit is a device for measuring the temperature of the semiconductor laser, and
the second pulse generation portion further includes a corrected peak value decision unit operable to determine a peak value of the second pulse signal which has a steadily decreasing relationship in accordance with the measured value.

7. The laser driving device according to claim 1, wherein the measurement unit is a device for measuring a voltage or a resistance of the semiconductor laser, and
the second pulse generation portion further includes a corrected peak value decision unit operable to determine a peak value of the second pulse signal which has a steadily increasing relationship in accordance with the measured value.

8. The laser driving device according to claim 1, wherein the digital signal is converted into a multi-pulse signal that includes at least a leading pulse signal and a trailing pulse signal corresponding to a succession number thereof, and a signal width of the second pulse signal is smaller than a width of the leading pulse signal.

9. The laser driving device according to claim 8, wherein a signal width of the second pulse signal that is added to the trailing pulse signal is equal to a width of the trailing pulse signal.

10. The laser driving device according to claim 1, wherein the digital signal is converted into a pulse signal having a width corresponding to a succession number, and a signal width of the second pulse signal is smaller than a width of the pulse signal.

11. The laser driving device according to claim 1, wherein a signal width of the second pulse signal is within the range of T/8-T/4 when T is a period of one channel clock.

12. The laser driving device according to claim 5, wherein the third pulse signal is generated at a leading edge of the first pulse signal, and the fourth pulse signal is generated at a trailing edge of the first pulse signal.

13. The laser driving device according to claim 1, wherein the pulse generation unit includes a pulse current source for producing a pulse current in accordance with the digital signal, a filter that is connected in parallel to the pulse current source and has a variable constant, and a filter control portion for controlling the constant of the filter in accordance with the measured value.

14. The laser driving device according to claim 13, wherein the filter control portion includes a unit operable to store a constant of the filter to be controlled by the filter control portion in accordance with the measured value.

15. The laser driving device according to claim 13, wherein the filter includes a plurality of combinations, each of which comprises a capacitor and a switch connected in series.

16. The laser driving device according to claim 13, wherein the filter includes a plurality of combinations, each of which comprises a capacitor, a switch and a resistor connected in series.

17. The laser driving device according to claim 15, wherein the filter further includes a resistor connected between the ground and a node of the capacitor and the switch.

18. The laser driving device according to claim 16, wherein the filter further includes a resistor connected between the ground and one of the nodes of the capacitor, the switch and the resistor connected in series.

19-22. (canceled)

23. An optical disk device comprising:
an optical pickup including a semiconductor laser for emitting a laser beam, the laser driving device according to claim 1, and an optical component for leading the laser beam onto an optical disk; and
a disk driving device for driving the optical disk.

24. A laser driving method for driving a semiconductor laser to emit pulse-like light in accordance with a digital signal, the method comprising:
a measuring step of outputting a measured value that changes in accordance with a temperature of the semiconductor laser; and
a pulse generation step of outputting a pulse-like signal having a shape corresponding to the measured value,
wherein the pulse generation step includes a first pulse generation step of generating a first pulse signal having a constant peak value, a second pulse generation step of generating a second pulse signal having a peak value that changes in accordance with the measured value, and an adding step of adding the second pulse signal to the first pulse signal so as to produce the pulse-like signal.

25. A laser driving integrated circuit for driving a semiconductor laser to emit pulse-like light in accordance with a digital signal, the integrated circuit comprising:
a first pulse generation portion for generating a first pulse signal having a constant peak value;
a second pulse generation portion for generating a second pulse signal having a peak value that changes in accordance with a measured value, the measured value changing in accordance with a temperature of the semiconductor laser; and
an adder for adding the second pulse signal to the first pulse signal so as to obtain a pulse-like signal to be delivered.

26. (canceled)
